(19) United States
(12) Patent Application Publication
(10) Pub. No.: US 2011/0184761 A1
(43) Pub. Date: Jul. 28, 2011

(54) Method and Apparatus for Estimating Patient Populations

(75) Inventors: Shipeng Yu, Exton, PA (US); Balaji Krishnapuram, King of Prussia, PA (US); Farbod Rahmanian, Leesport, PA (US); Faisal Farooq, Norristown, PA (US)

(73) Assignee: Siemens Medical Solutions USA, Inc., Malvern, PA (US)

(21) Appl. No.: 13/013,314

(22) Filed: Jan. 25, 2011

Related U.S. Application Data
(60) Provisional application No. 61/297,855, filed on Jan. 25, 2010.

(51) Int. Cl. G06Q 50/00

(52) U.S. Cl. 705/3; 705/2

(57) ABSTRACT

The methods and apparatuses of the present invention provide for a continuous abstraction of randomly sampled patient data and shortened data processing cycle times when an accurate sample population size is unknown at the beginning of the sampling process. The present invention estimates an initial medical patient population size for the purpose of randomly sampling that population. The estimated population size is calculated based on historical patient population data and is corrected at the end of the sample time period. Under-sampling is remediated at the end of the sample time period, during which continuous sampling of the patient data is carried out to provide interim and immediately available sampled patient data. Criteria for medical patient population sizing and sampling are provided by health care organizations responsible for administrating health care quality improvement standards.

### CROSS REFERENCE TO RELATED APPLICATIONS

This application claims priority to the U.S. Provisional Patent Application Ser. No. 61/297,855, titled “Effective Real Time and Continuous Sampling When Total Patient Population is Unknown”, filed on Jan. 25, 2010; the contents of which are herein incorporated by reference in their entirety.

### FIELD OF THE INVENTION

The disclosure relates generally to medical information processing systems, and more particularly, to computerized methods and apparatuses for estimating and later verifying sample patient populations within a health care management system where total patient populations are unknown.

### BACKGROUND OF THE INVENTION

Health care providers accumulate vast amounts of information as part of the overall process of health care management and administration. A patient's records alone often contain vast quantities of data, particularly where long term care is involved. Much of this data is continuously input and updated both during the patient's period of care and afterward. As part of the billing procedures associated with patent processing, portions of this data must be transmitted to insurance companies and health care administration agencies for processing. This information may be used to verify certain treatment criteria and appropriate standards of care. This data is also use to determine and facilitate the financial arrangements between health care insurers and providers.

In addition to basic health care management and administration, health care providers may also participate in quality improvement (QI) and meaningful use (MU) initiatives, for example, as related to critical care patients and electronic medical record (EMR) systems, respectively. The Center for Medicare and Medicaid Services (CMS) is one such organization that is responsible for implementing quality improvement standards pertaining to acute care and long term care provided for Medicare and Medicaid patients. In order to participate in these programs, select data from sample populations of target patients must be transmitted to the quality improvement organization for review. To facilitate this, the quality improvement organization may specify sampling guidelines regarding the target patient populations of interest. Finally, financial consideration may be provided to the health care providers as compensation for their efforts in providing that data as well as for improvements achieved in the level of care provided.

An undesirable part of this process, however, is that significant latencies exist between the discharge of a patient, the sampling of the patient population, the collection and transmission of sampled patient data, and the resulting financial payment to the health care provider for process participation. In particular, the need to wait for all patients within a target population to be coded and discharged before determining an accurate, total population size and subsequent sampling of the same provides a significant delay element in the overall process. Therefore, it would be beneficial to health care providers to shorten the time between the end points in the entire process: patient coding and financial remuneration. Methods are needed for providing approximations of the sample patient populations. These approximations can be continuously used to provide preliminary patient data which can be supplemented later, as needed, based on final, definitive patient population size.

### SUMMARY OF THE INVENTION

According to one embodiment of the present invention, a method of predictive sampling of a medical patient population is provided including: estimating an initial patient population (M) for a sample time period, the initial patient population based on historical sample populations for the sample time period; calculating an initial sample population (m) for the sample time period, the initial sample population based on the estimated initial patient population and minimum sample size tables; sampling the initial patient population (M) randomly until m population members are sampled; recalculating a minimal sample population (n) for the sample time period, the minimal sample population (n) based on an actual patient population (N) for the time period and the minimum sample size tables; and correcting for an under-sampling of the actual patient population (N). In certain aspects, the step of sampling further includes randomly determining a sample staring point between a first patient within the initial patient population and a k^{th} patient within the initial patient population, wherein k=M/m; and/or sampling of the initial sample patient population occurs every k^{th} element until m population members are sampled. In other aspects, the step of correcting further includes determining that the under-sampling results from the actual patient population (N) being greater than the initial patient population (M) for the sample time period; and resampling a reconstituted patient population (N′) upon the determination, the reconstituted patient population being the actual patient population (N) without the previously sampled population members. In yet other aspects, the step of resampling includes recalculating an additional sample population (m′), the additional sample population is based on a difference between the minimal sample population (n) and the initial sample population (m); and resampling the reconstituted patient population (N′) occurs randomly for the additional sample population (m′). Additionally, the method includes storing a plurality of patient records in a patient database, the plurality of patient records including historical medical data related to the medical patient population, the historical sample populations being derived from the historical medical data; and submitting the patient records from the initial sample population to a health care quality standards provider.

In other aspects of the invention the medical patient population is sampled for one of quality of care analysis, inclusion in a clinical trial, or inclusion in a meaningful use initiative; the medical patient population is sampled for quality of care analysis and the minimal sample size tables pertain to a core measure, the quality of care analysis being conducted by a health care quality standards provider; the core measure is one of heart failure, acute myocardial infarction, pneumonia, surgical care improvement, stroke, or venous thromboembolism; and/or the health care quality standards provider is the Center for Medicare and Medicaid Services. In yet other aspects, the step of sampling occurs continuously and in real-time as the patient population is admitted to a health care provider, the actual patient population being unknown until the end of the sample time period; the minimum sample size data is a percentage of the patient populations; and the minimum sample size data is a fixed number of patients.

In another embodiment, the invention is a computer-based predictive sampling system, the sampling system is coupled to a sample population database having historical population data for medical patients, the sampling subsystem is also coupled to a standard-based sampling requirements database having minimum sample size tables, the sampling system includes: an estimation subsystem for estimates an initial patient population (M) and collecting an actual patient population (N), the estimation system also estimates an initial sample population (m) based on the minimum sample size tables, the initial patient population (M) being based on the historical population data, the initial patient population (M) and the actual patient population (N) being determined before and after the sample time period respectively; a verification subsystem for calculating a minimal sample population (n) for the sample time period based on the actual patient population (N) and the minimum sample size tables, the verification subsystem further calculating a reconstituted patient population (N′) upon a determination of undersampling during the sample time period; and a sampling subsystem for sampling randomly the initial patient population (M) and the reconstituted patient population (N′), the random sampling performed on the initial patient population (M) for m population members, the reconstituted patient population being determined by the verification subsystem to be the actual patient population (N) without the previously sampled population members, the random sampling additionally performed on the reconstituted patient population (N′) based on a difference between the minimal sample population (n) and the “m” sampled population members. In one aspect, the predictive sampling system is part of a computerized medical quality measures system, the minimum sample size tables are provided by a health care quality standards provider, and patient data related to the sampled patients is transmitted to the health care quality standards provider for evaluation.

According to another embodiment of the invention a method of sampling a patient population for quality of care analysis is provided, the quality of care analysis being conducted by a health care quality standards provider, the method including: storing a plurality of patient records in a patient database, the plurality of patient records including historical data related to a target patient population, the target patient population having a common core measure; estimating an initial patient population (M) for a sample time period, the initial patient population being based on the historical data; calculating an initial sample patient population (m) for the sample time period; the initial sample patient population based on the estimated initial patient population and minimum sample size data provided by the health care quality standards provider; sampling the initial patient population (M) randomly until m patient population members are sampled; submitting after each sampling the patient records for the initial sample patient population to the health care quality standards provider; determining an actual patient population (N) for the time period; recalculating a minimal sample patient population (n) for the sample time period based on the actual patient population (N) and the minimum sample size data provided by the health care quality standards provider; recalculating an additional sample patient population (m′), the additional sample patient population based on a difference between the minimal sample patient population (n) and the initial sample patient population (m); resampling randomly a reconstituted patient population (N′) until m′ patient population members are sampled, the reconstituted patient population being the actual patient population (N) without the members previously sampled; and submitting the patient records for the additional sample patient population to the health care quality standards provider. In one additional aspect, the first sampling step includes randomly determining a sample staring point between a first patient within the initial patient population and a k^{th} patient within the initial patient population, wherein k=M/m; and sampling the initial sample patient population every k^{th} element until m patients are sampled.

### BRIEF DESCRIPTION OF THE DRAWINGS

The accompanying drawings, which are incorporated in and constitute part of this specification, illustrate embodiments of the invention and together with the description, serve to explain the principles of the invention. Like references indicate similar elements among the figures and such elements are illustrated for simplicity and clarity and have not necessarily been drawn to scale. The embodiments illustrated herein are presently preferred, it being understood, however, that the invention is not limited to the precise arrangements and instrumentalities shown, wherein:

FIG. 1 is a block diagram of a computer processing system to which the present invention may be applied according to an embodiment of the present invention;

FIG. 2 shows an patient sampling subsystem according to an embodiment of the present invention; and

FIGS. 3A and 3B show a process flow diagram for sampling a patient population and correcting the same according to an embodiment of the present invention.

### DESCRIPTION OF PREFERRED EMBODIMENTS

To facilitate a clear understanding of the present invention, illustrative examples are provided herein which describe certain aspects of the invention. However, it is to be appreciated that these illustrations are not meant to limit the scope of the invention, and are provided herein to illustrate certain concepts associated with the invention.

It is also to be understood that the present invention may be implemented in various forms of hardware, software, firmware, special purpose processors, or a combination thereof. Preferably, the present invention is implemented in software as a program tangibly embodied on a program storage device. The program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the program (or combination thereof) which is executed via the operating system. In addition, various other peripheral devices may be connected to the computer platform such as an additional data storage device and a printing device.

It is to be understood that, because some of the constituent system components and method steps depicted in the accompanying figures are preferably implemented in software, the actual connections between the system components (or the process steps) may differ depending upon the manner in which the present invention is programmed.

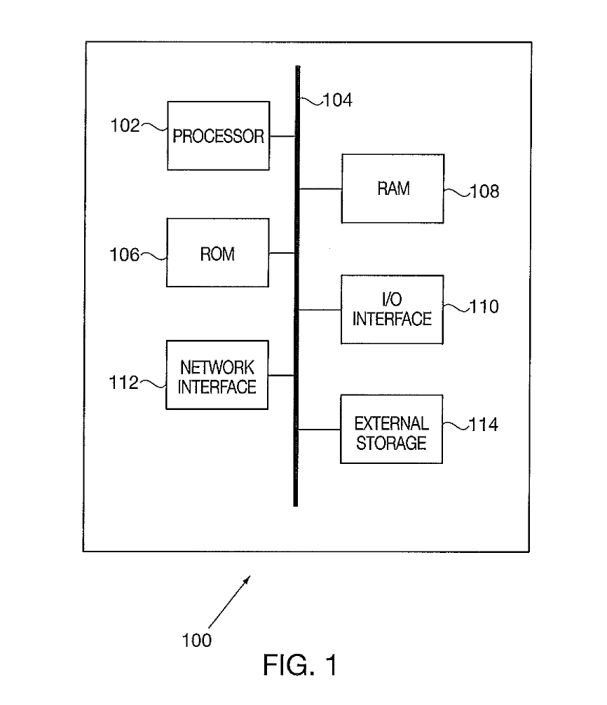

FIG. 1 is a block diagram of a computer processing system 100 to which the present invention may be applied according to an embodiment of the present invention. The system 100 includes at least one processor (hereinafter processor) 102 operatively coupled to other components via a system bus 104. A read-only memory (ROM) 106, a random access memory (RAM) 108, an I/O interface 110, a network interface 112, and external storage 114 are operatively coupled to the system bus 104. Various peripheral devices such as, for example, a display device, a disk storage device (e.g., a magnetic or optical disk storage device), a keyboard, and a mouse, may be operatively coupled to the system bus 104 by the I/O interface 110 or the network interface 112.

The computer system 100 may be a standalone system or be linked to a network via the network interface 112. The network interface 112 may be a hard-wired interface. However, in various exemplary embodiments, the network interface 112 can include any device suitable to transmit information to and from another device, such as a universal asynchronous receiver/transmitter (UART), a parallel digital interface, a software interface or any combination of known or later developed software and hardware. The network interface may be linked to various types of networks, including a local area network (LAN), a wide area network (WAN), an intranet, a virtual private network (VPN), and the Internet.

The external storage 114 may be implemented using a database management system (DBMS) managed by the processor 102 and residing on a memory such as a hard disk. However, it should be appreciated that the external storage 114 may be implemented on one or more additional computer systems. For example, the external storage 114 may include a data warehouse system residing on a separate computer system.

Those skilled in the art will appreciate that other alternative computing environments may be used without departing from the spirit and scope of the present invention. Further, one particular medical application of the present invention, evaluation of the CMS core measurement requirement, is used as a working example of the description of the invention that follows. Using CMS core measurements, a health care provider's performance is measured according to the quality and standards of care established by CMS. The primary conditions monitored by CMS for such purposes are: heart failure (HF), acute myocardial infarction (AMI), pneumonia (PN), surgical care improvement project (SCIP), stroke (STK) and venous thromboembolism (VTE). Within each of these groups, health care providers may voluntarily submit relevant data for patients treated during a certain period of time (e.g., one month or one calendar quarter). New groups are constantly being added to this list that adds to the burden of reporting and the delays make it further unwieldy. In the examples provided below, the reporting involves the random sampling of target populations, i.e., those patients falling within one of the monitored conditions. However, those skilled in the art will appreciate that other medical and possibly non-medical applications for the invention exist.

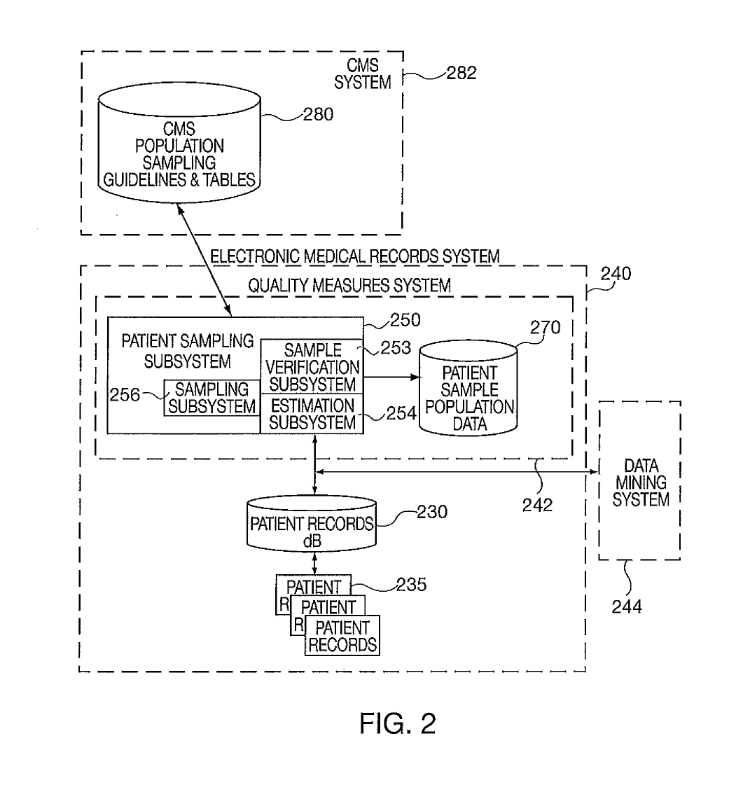

FIG. 2 is a high level block diagram of a computer system according to one embodiment of the present invention. The health care provider's computer systems ideally include an electronic medical records (EMR) system 240 that contains patient data records 235 which are, in turn, contained within health care provider's patient database 230. The computer system may also include data mining system 244 that filters and sorts patient records provided by the quality measures subsystem 242. By way of example, the REMIND™ system developed by Siemens™ is one such data mining system that may be coupled to the Soarian® EMR system and the Soarian® Quality Measures subsystem—the latter being a suite of data analysis tools designed to evaluate and report various quality measures from the electronic patient records database as mined by the REMIND™ system at its direction. Patient sampling subsystem 250 is included within the quality measures subsystem 242 and is coupled to and exchanges data with the patient data records database 230 containing patient record data 235. External to the health care provider system is CMS sampling guidelines database 280 provided by CMS computer system 282 which is also coupled to and exchanges data with quality measures subsystem 242 and sampling subsystem 250.

Patient sampling subsystem 250, in turn, includes a sampling subsystem 256, an estimation subsystem 254 and a sample verification subsystem 253. Finally the quality measures subsystem 242 includes its own database of patient sample population data created according to the overall processes described below. It should be appreciated that the EMR system 240 and its subsystems may be physically made up of any number of combined computer processing systems 100. Also, most of the functional portions of the EMR system are comprised of software modules designed for use on such computer systems. In one preferred embodiment, the patient sampling subsystem 250 and its subsystems are coded in the form of modular software to run on the quality measures subsystem and execute the methods described below.

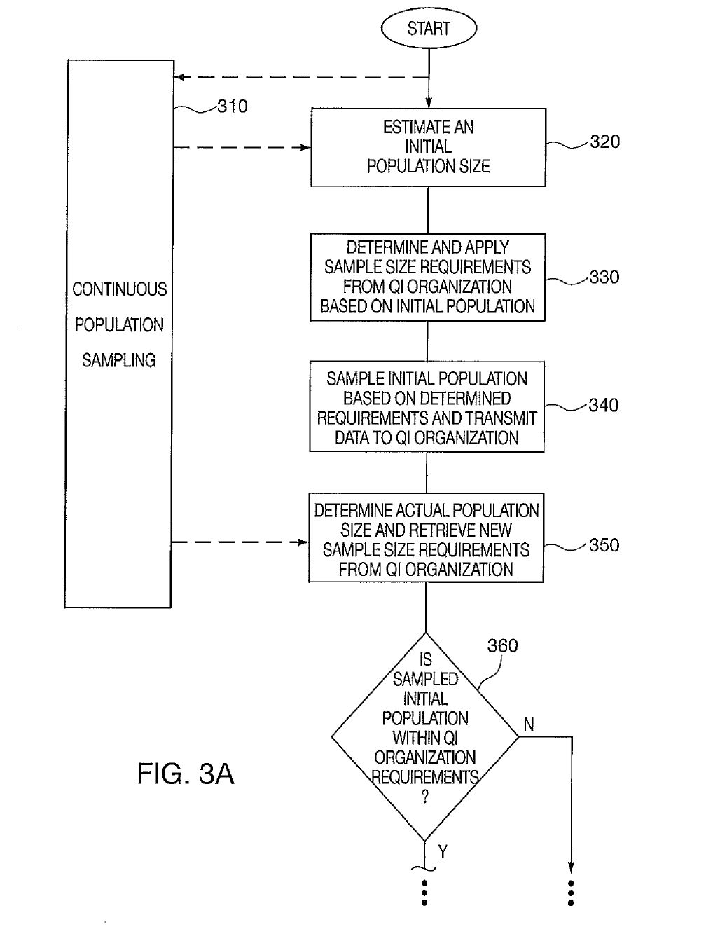

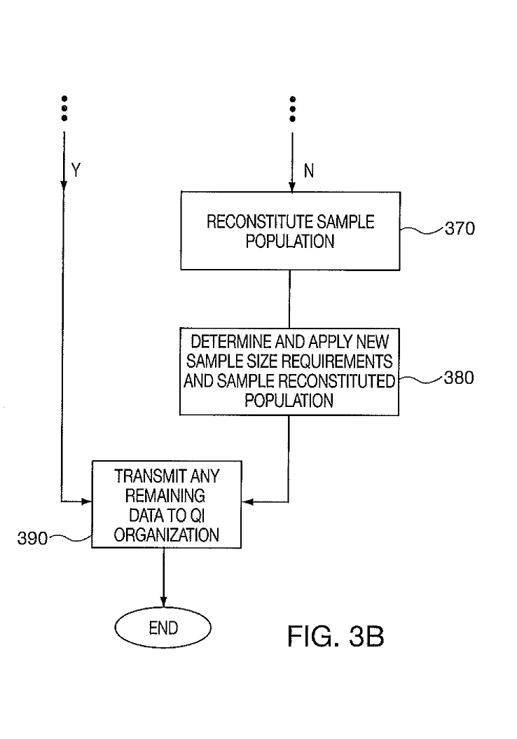

FIGS. 3A and 3B show a process flow diagram that illustrates a sampling estimation and correction process according to one preferred embodiment of the invention. As mentioned, the CMS core measure requirement is used as a running example of this process for illustration purposes only. CMS presently requires each hospital to submit certain core measure results, but defines only monthly and quarterly sampling schemes for core measure abstractions. Therefore, health care providers typically have to wait a month or more after the end of a sampling period to determine an accurate patient population size from which patient data can be accurately sampled, culled and transmitted to CMS for that sample period. In this regard, CMS publishes sampling requirements and guidelines in the form of sampling data tables within CMS database 280 and CMS computer system 282. In this example, the CMS requirements dictate that: 1) the sampled target patient population has to be the equivalent of a simple random sampling method or a systematic random sampling; 2) the sampling is applied consistently across health care provider member hospitals and within sample time periods (months or quarters); and 3) a minimum number of samples must be submitted to CMS depending on the health care provider's target patient population size. With respect to 3), the CMS sampling data tables specify that a particular number of samples be taken, or alternatively that a certain percentage of the target patient population be sampled. In some cases, particularly where the target population is small (e.g., less than a given number, say 10 patients), the CMS tables specify that there is no sampling to be performed but rather the data from the entire target patient population be submitted to CMS. The apparatuses and methods of this invention are generally directed at the former case in which sampling is required.

Simple random sampling, by CMS definition, refers to the selection of a sample size (n) from a population sized (N) in such a way that every patient case has the same chance of being selected. Selections according to this method may include a random number generation system that is used to select n patient samples from the N population size. Systematic random sampling, by CMS definition, is the selection of every “k^{th}” record from a population size (N) in such a way that the sample size n is obtained, where k is less than or equal to N/n. Under this method, the first sample record must be randomly selected before taking every k^{th} record according to the two step process: a) randomly selecting the starting point by choosing a number between one and “k” using a table of random numbers or a computer-generated random number, and b) selecting every k^{th} record thereafter until the selection of the sample size n is completed.

Regardless of the sampling method selected (simple or systematic), the process shown in FIGS. 3A and 3B includes a continuous running process 310 which collects information regarding the health care provider's target patient population within a sample time period (month, quarter etc). Continuously running process 310 tallies the number of target patient admissions and discharges as well as collects all relevant medical data pertaining thereto and calculates certain background statistics. This is performed as a means to provide input to other process steps, such as estimates regarding an initial target patient population (M) and adjustments to initial estimate, until the actual final target population (N) is determined for any particular sample time period.

With reference to FIG. 3A, at step 320, at about the beginning of a sample time period, an estimate of the initial target patient population is made by the estimation subsystem 254 based on any of several criteria. As an example, if a given hospital sees 120 heart attack patients/year then “M” may be estimated to be 12 heart attack patients/month. Alternatively, if heart attacks are more prevalent in the winter months at a particular hospital, say in colder climates where many are due to snow shoveling, then that hospital's historical data may show that 20 such cases have been admitted during each month of January and February over the past 10 years while the remaining 80 yearly cases are spread evenly about the remaining 10 months (8 patients/month) over the same 10 years. In this case, the estimation of the target patient population for January may be that found in the same month for the past 10 years (20) versus an average/month for those 10 years. In any case of initial population estimation, historical data is preferably used to provide an initial target population M. It should be appreciated that the historical data itself may be adjusted for a variety of reasons without departing from the general proposition that the initial estimate is based on historical data. General population changes, such as the movement of people into or out of a particular geographic region serviced by the health care provider, is one example in which it may be desirable and more realistic to alter actual historical data.

Once the initial target population (M) is estimated, the patient sampling subsystem 250 consults the CMS database for appropriate sampling tables and calculates an initial sample population (“m”) based on the specified CMS sampling requirements and the estimated initial target population for the sample time period. This is shown as step 330. If the sample tables call for a specific number of samples for the estimated population size then that number is used as “m.” If, instead, a sample percentage is required by the CMS specifications, then that percentage is applied and the initial sample population (m) is calculated therefrom.

At step 340 the initial target population is continuously sampled by the sampling subsystem 256 as the target population is processed in real time by the health care provider. Once patient coding is completed on each patient, usually within one week from the discharge date, then the patients are available for inclusion within the initial target population (M). In one preferred aspect, systematic random sampling is employed and with the presumption that M is accurate, every “k^{th}” patient identified within the target population is sampled, where k<=M/m and the starting patient is randomly determined in a range between 1 and M/m. Step 340 is repeated and sampling of each “k^{th}” patient continues until the m samples are taken and transmitted to CMS during the sample period.

At the end of the sample period, step 350, the actual target population size (N) is determined with the assistance of continuously running process 310. The patient sampling subsystem 250 consults the CMS database for appropriate sampling tables and calculates a minimal sample population (n) based on the specified CMS sampling requirements and the actual target population for the sample time period. Sample verification subsystem 253 then performs a series of steps to verify that the minimal sample population (n) size is met by the quality measure subsystem 242.

At step 360 the process of the present invention makes a series of determinations. First, if it is determined that N=M, then the predetermined initial sample population m was properly calculated (m=n), and if m samples were taken, then a minimal sample population was recorded for the sample time period and no further sampling is needed. Second, if it is determined that N<M, then the predetermined initial sample population m was overestimated (m>n), and if m samples were taken, then a minimal sample population was still recorded for the sample time period and no further sampling is needed. Both of these conditions result in a CMS compliant sampling situation at decision step 360 (“Yes” (“Y”) path) and any remaining untransmitted patient data samples comprising part of the m samples are submitted to CMS at step 390 for processing. This ends the sampling for the sample time period being processed.

However, if it is determined in step 350 that N>M and the initial sample population number m<n then the actual target population was undersampled based on the CMS requirements. Additional samples of at least n−m (hereinafter “m′”) in number need to be extracted from the actual sample population (N). In this event, (“No” (“N”) path from decision step 360) the population is reconstituted at step 370 by the sample verification subsystem 253 so that the sample population is composed of the actual target population with the previously sampled members (m) removed therefrom (hereinafter “N′”). Then m′ additional samples are randomly selected at step 380 by the sampling subsystem 256 from the reconstituted population N′ to meet the minimal CMS sampling requirements. As with the two cases above, the additional m′ samples are then submitted to CMS at step 390 for processing. This ends the sampling for the sample time period being processed.

In practical effect, and with respect to the quality measures implemented through CMS, the present invention can significantly reduce the overall payment processing time for health care providers. In a manual processing environment, i.e., without the aid of a quality measures subsystem, abstractors typically examine patient data and randomly sample and submit to CMS the sampled data anywhere between approximately 15 days to one month after the end of a one-month sample period. This is so because the last member of the target population needed to be coded following discharge from the hospital before the abstractors were able to determine the actual population size N and related minimal sample population n. After sampling, data culling and submission to the health care quality standards provider (e.g., CMS), the related payment(s) from the same are distributed accordingly.

Using the process of this invention, shorter, periodic patient data samples may be submitted to the quality standards provider (e.g., weekly). Thus in a monthly submission scenario using weekly process execution, approximately three-quarters of the estimated number of samples have already been taken and processed by the end of week three, and the sample population data has been culled and transmitted to the quality standards provider. By the end of week four, or within a few days thereafter, the final estimated samples are taken. Those sample population data are then culled and transmitted to the quality standards provider. If additional samples are not needed because the number of specified samples was greater than or equal to the required number, then no additional sampling is performed. The quality standards provider possesses all the required data and payments are processed accordingly. If it turns out that the target patient population has been under-sampled, then additional samples are taken, culled for data and transmitted. However, only the additional samples require processing at this point, thereby reducing total end-of-month processing time. Further, the previously submitted data has already been received and processing begun by the quality standards provider, and the latency related to the remaining samples is minimal as compared to providing all the hospitals sampled data at some point well past the end of the month.

Two statistical observations should be noted in the context of the present invention. First, the initial population estimation process is typically very accurate with variations being accounted for easily. It has been empirically demonstrated, in the medical context, that historical patient population data is an extremely strong predictor of future population data. This statistical consistency is one significant advantage of the present invention given that accurate initial patient population estimation provides accurate sampling during the real-time portion of the patient processing. Historical, statistical consistency is so predictable, in fact, that modern medical organizations, such as CMS, actually use a health care provider's historical data in their own determinations of reimbursement rate estimations as well as other processes. This statistical consistency is particularly prevalent in the Medicare/Medicaid context in which patient populations are typically senior citizens having a historically stable set of health care issues.

Second, the present invention and the statistical processes described herein have been empirically verified to be compliant with the sampling criteria provided by several health monitoring organization. For example, the sampling method described above with respect to Soarian® Quality Measures subsystem is being accepted by CMS for numerous health care providers as compliant with its specified random sampling guidelines. Although other health care monitoring organizations may have different statistical sampling criteria than that of CMS, the hybrid sampling approach comprised of systematic sampling during real-time patient processing followed by correction through simple sampling following total patient population determination can be shown, in most cases, to meet stringent statistical sampling requirements. The certification of the use of medical systems that practice the method of the present invention are typically done on a case-by-case basis, however, and each health care provider must apply for approval and certification from a health care monitoring organization with which it participates.

Again, while the invention has been described with respect to a health care provider's participation in a quality measures program, it should be apparent that the apparatus and methods of the invention are applicable to other medically-related statistical sampling processes. In particular, they are applicable where the total patient population sizes are unknown at first but advantages can be had if they are estimated and then corrected after the actual total patient population is known. In clinical trials, for example, a clinical trial sponsor, such as a pharmacological development company, may desire a target patient population to test the administration of a new drug. In this clinical trial context, a cohort may be created in which a certain set of inclusion and exclusion criteria are specified by the clinical trial sponsor so as to create a clinical trial patient population. That cohort may then be created in real-time as patients are processed by the health care provider. The definition of the statistical criteria by which the cohort patient population should be sampled is provided by the clinical trial sponsor and applied to the patient population processed in real-time. At the end of sample periods, the cohort patient population may be found to be either properly sampled or undersampled according to such criteria. In the latter case, the cohort population may be adjusted by the health care provider according to the methods and apparatuses of the present invention to arrive at a proper sample cohort population.

In another context, the health care provider may participate in a meaningful use (MU) program in which a health quality monitoring organization provides financial incentives to health care providers to use certain information technologies (IT) in connection with patient processing. Examples of such IT systems include electronic medical records systems and electronic drug dispensing systems. In this context, the health care providers may be provided financial stipends for the proper use of such IT systems in connection with patient processing. The use of the IT systems may be reported to the health quality monitoring organization in real-time as patients are processed by the health care provider. The definition of the statistical criteria by which the patient population processed with the IT system should be sampled is provided by the health quality monitoring organization which is applied to the patient population processed in real-time. At the end of sample periods, the patient population may be found to be either properly sampled or undersampled according to such criteria. In the latter case, the population may be adjusted by the health care provider according to the methods and apparatuses of the present invention to arrive at a proper sample population.

As shown in FIGS. 1-3, this invention is preferably implemented using a general purpose computer system. However the systems and methods of this invention can be implemented using any combination of one or more programmed general purpose computers, programmed microprocessors or micro-controllers and peripheral integrated circuit elements, ASIC or other integrated circuits, digital signal processors, hardwired electronic or logic circuits such as discrete element circuits, programmable logic devices such as a PLD, PLA, FPGA or PAL, or the like. In general, any device capable of implementing a finite state machine that is in turn capable of implementing the flowchart shown in FIGS. 3A and 3B can be used to implement this system.

While the invention has been shown and described with reference to specific preferred embodiments, it should be understood by those skilled in the art that various changes in form and detail may be made therein without departing from the spirit and scope of the invention as defined by the following claims.

What is claimed is:

1. A method of predictive sampling of a medical patient population comprising:
estimating an initial patient population (M) for a sample time period, said initial patient population based on historical sample populations for said sample time period;
calculating an initial sample population (m) for said sample time period, said initial sample population based on said estimated initial patient population and minimum sample size tables;
sampling said initial patient population (M) randomly until m population members are sampled;
recalculating a minimal sample population (n) for said sample time period, said minimal sample population (n) based on an actual patient population (N) for said time period and said minimum sample size tables; and
correcting for an under-sampling of said actual patient population (N).

2. The method of claim 1 wherein said step of sampling further comprises:
randomly determining a sample staring point between a first patient within said initial patient population and a k^{th} patient within said initial patient population, wherein k=M/m; and
sampling said initial sample patient population every k^{th} element until m population members are sampled.

3. The method of claim 1 wherein said step of correcting further comprises:
determining that said under-sampling results from said actual patient population (N) being greater than said initial patient population (M) for said sample time period; and
resampling a reconstituted patient population (N′) upon said determination, said reconstituted patient population being said actual patient population (N) without said previously sampled population members.

4. The method of claim 3 wherein said step of resampling comprises:
recalculating an additional sample population (m′), said additional sample population based on a difference between said minimal sample population (n) and said initial sample population (m); and
resampling said reconstituted patient population (N′) randomly for said additional sample population (m′).

5. The method of claim 1 further comprising storing a plurality of patient records in a patient database, said plurality of patient records including historical medical data related to said medical patient population, said historical sample populations being derived from said historical medical data.

6. The method of claim 5 further comprising submitting said patient records from said initial sample population to a health care quality standards provider.

7. The method of claim 1 wherein said medical patient population is sampled for one of: quality of care analysis, inclusion in a clinical trial, or inclusion in a meaningful use initiative.

8. The method of claim 7 wherein said medical patient population is sampled for quality of care analysis and said minimal sample size tables pertain to a core measure, said quality of care analysis being conducted by a health care quality standards provider.

9. The method of claim 8 wherein said core measure is one of: heart failure, acute myocardial infarction, pneumonia, surgical care improvement, stroke, or venous thromboembolism.

10. The method of claim 8 wherein said health care quality standards provider is the Center for Medicare and Medicaid Services.

11. The method of claim 1 wherein said step of sampling occurs continuously and in real-time as the patient population is admitted to a health care provider, said actual patient population being unknown until the end of said sample time period.

12. The method of claim 1 wherein said minimum sample size data is a percentage of said patient populations.

13. The method of claim 1 wherein said minimum sample size data is a fixed number of patients.

14. A computer-based predictive sampling system, said sampling system coupled to a sample population database having historical population data for medical patients, said sampling subsystem also coupled to a standard-based sampling requirements database having minimum sample size tables, said sampling system comprising:
an estimation subsystem for estimating an initial patient population (M) and collecting an actual patient population (N), said estimation system also estimating an initial sample population (m) based on said minimum sample size tables, said initial patient population (M) being based on said historical population data, said initial patient population (M) and said actual patient population (N) being determined before and after said sample time period respectively;
a verification subsystem for calculating a minimal sample population (n) for said sample time period based on said actual patient population (N) and said minimum sample size tables, said verification subsystem further calculating a reconstituted patient population (N′) upon a determination of undersampling during said sample time period; and
a sampling subsystem for sampling randomly said initial patient population (M) and said reconstituted patient population (N′), said random sampling performed on said initial patient population (M) for m population members, said reconstituted patient population being determined by said verification subsystem to be said actual patient population (N) without said previously sampled population members, said random sampling additionally performed on said reconstituted patient population (N′) based on a difference between said minimal sample population (n) and said “m” sampled population members.

15. The computer-based system of claim 14 wherein said predictive sampling system is part of a computerized medical quality measures system, said minimum sample size tables are provided by a health care quality standards provider, and patient data related to said sampled patients is transmitted to said health care quality standards provider for evaluation.

16. A method of sampling a patient population for quality of care analysis, said quality of care analysis being conducted by a health care quality standards provider, the method comprising:
storing a plurality of patient records in a patient database, said plurality of patient records including historical data related to a target patient population, said target patient population having a common core measure;
estimating an initial patient population (M) for a sample time period, said initial patient population being based on said historical data;
calculating an initial sample patient population (m) for said sample time period; said initial sample patient population based on said estimated initial patient population and minimum sample size data provided by said health care quality standards provider;
sampling said initial patient population (M) randomly until m patient population members are sampled;
submitting after each sampling said patient records for said initial sample patient population to said health care quality standards provider;
determining an actual patient population (N) for said time period;
recalculating a minimal sample patient population (n) for said sample time period based on said actual patient population (N) and said minimum sample size data provided by said health care quality standards provider;
recalculating an additional sample patient population (m′), said additional sample patient population based on a difference between said minimal sample patient population (n) and said initial sample patient population (m);
resampling randomly a reconstituted patient population (N′) until m′ patient population members are sampled, said reconstituted patient population being said actual patient population (N) without the members previously sampled; and
submitting said patient records for said additional sample patient population to said health care quality standards provider.

17. The method of claim 16 wherein said first sampling step includes:
randomly determining a sample staring point between a first patient within said initial patient population and a k^{th} patient within said initial patient population, wherein k=M/m; and
sampling said initial sample patient population every k^{th} element until m patients are sampled.

18. A method of predictive sampling of a medical patient population comprising:
real time and continuous sampling of the medical patient population when the final medical patient population size is unknown.
